(19) United States
(12) Patent Application Publication
(10) Pub. No.: US 2012/0054812 A1
(43) Pub. Date: Mar. 1, 2012

(54) METHOD AND APPARATUS FOR MULTIPLEXING SERVICE DELIVERY WITH QUALITY OF SERVICE (QoS) GUARANTEE

(75) Inventor: Nam Kyung LEE, Daejeon (KR)

(73) Assignee: Electronics and Telecommunications Research Institute, Daejeon (KR)

(21) Appl. No.: 13/218,934

(22) Filed: Aug. 26, 2011

(30) Foreign Application Priority Data
Aug. 26, 2010 (KR) 10-2010-0082911

(51) Int. Cl. H04N 7/173

(52) U.S. Cl. 725/109

(57) ABSTRACT

Provided is a service providing method and system by interoperation between service managers. Each of the service managers may manage an independent service area. Since the service managers interoperate with each other, a service target of an available service resource managed by a single service manager may be expanded to the entire service area. The entire service area may correspond to an area of summing up a service area managed by each of the service managers. Through the above expansion, a service may be efficiently delivered and provided to ensure a quality of service (QoS) requested by a user.

### CROSS-REFERENCE TO RELATED APPLICATION

This application claims the benefit of Korean Patent Application No. 10-2010-0082911, filed on Aug. 26, 2010, in the Korean Intellectual Property Office, the disclosure of which is incorporated herein by reference.

### BACKGROUND

1. Field of the Invention

The present invention relates to a method and apparatus for effectively providing a broadcasting and communication service in an Internet Protocol Television (IPTV) system.

2. Description of the Related Art

An Internet Protocol Television (IPTV) service provided by an IPTV system may be represented by a broadcasting and communication service and the above basic service may have a mutually fused real-time characteristic.

The IPTV service may be independently and exclusively provided by a plurality of service areas and service providers belonging to the plurality of service areas. Accordingly, an available service resource satisfying a quality of service (QoS) requested by a user may be constrained within a service area of a system providing a corresponding service to the user.

### SUMMARY

According to an aspect of the present invention, there is provided a service delivery platform, including: a media service platform to provide a service to a user; and a plurality of service managers to manage at least one service resource. The media service platform may transmits a service request of the user to a predetermined service manager and the predetermined service manager may select a service resource for providing a service from the at least one service resource managed by each of the plurality of service managers in interoperation with other service managers.

The media service platform may include: a context information storage block to store context information of the user; a service search block to search for a service supported by the media service platform, and to provide the user with a result of the service search; a service configuration block to configure and manage a service profile based on the service request of the user and the context information of the user; and a user profile block to store a profile of the user.

The predetermined service manager may provide, to another service manager, an available service resource among at least one service resource managed by the predetermined service based on a quality of service (QoS) agreement between the plurality of service managers.

The predetermined service manager may select a service resource for providing a service from the at least one service resource based on a criterion included in the service request.

The service resource may have a service resource type. The at least one service resource managed by each of the plurality of service managers may have the same type as a service type requested by the service request.

According to another aspect of the present invention, there is provided a service manager managing a plurality of service resources, including: a service operation block to receive a service request from a media service platform, and to transmit a response to the media service platform in response to the service request; and a service bridge block to provide an access to a service resource managed by another service manager within a network. The service manager may select a service resource for providing a service according to the service request in interoperation with the other service manager.

According to still another aspect of the present invention, there is provided a service providing method, including: receiving a service request from a user; collecting a service resource associated with the service request from service resources managed by a plurality of service managers; determining a service resource for providing a service by analyzing the collected service resources; allocating the determined service resource to the user; and providing the allocated service resource to the user.

The service request may include a QoS. The determining may include: analyzing a QoS of each of the collected service resources; and selecting, from service resources satisfying the QoS, the service resource for providing the service. The service request may have a service type. The service resource associated with the service request may have the same service type as a service type of the service request.

According to embodiments of the present invention, there may be provided a service management apparatus and method that may manage an independent service area.

Also, according to embodiments of the present invention, there may be provided a system and method that may expand a target of an available service resource to a total service area managed by a plurality of service managers through interoperation between service management apparatuses.

Also, according to embodiments of the present invention, there may be provided a system and method that may expand a target of an available service resource to a total service area and ensure a QoS requested by a user.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a service delivery platform according to an embodiment of the present invention;

FIG. 2 is a diagram illustrating an example of a service based operation structure according to an embodiment of the present invention;

FIG. 3 is a diagram illustrating a message flow between constituent blocks of a service manager according to an embodiment of the present invention;

FIG. 4 is a diagram illustrating a connection between a plurality of service areas according to an embodiment of the present invention;

FIG. 5 is a diagram illustrating an interoperation between a plurality of service managers managing different service areas according to an embodiment of the present invention; and

FIG. 6 is a flowchart illustrating an operation of a service manager according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

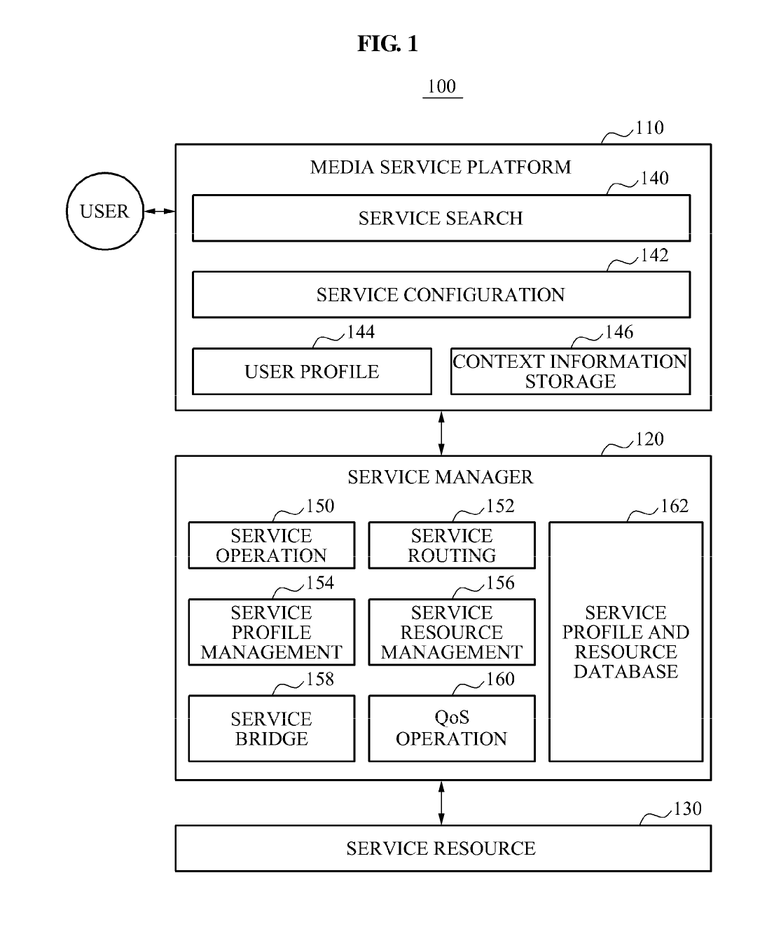

FIG. 1 is a diagram illustrating a service delivery platform 100 with a quality of service (QoS) guarantee according to an embodiment of the present invention.

The service delivery platform 100 may provide an effective service delivery function of ensuring a QoS requested by a user.

The service delivery platform 100 may include a media service platform 110, a service manager 120, and a service resource 130.

The media service platform 110 may provide the same functionality as a service portal of providing a service to users. For example, without a direct access to the service manager 120, a user may request the media service platform 110 for a service and may receive the service from the media service platform 110.

The media service platform 110 may include a service search block 140, a service configuration block 142, a user profile block 144, and a context information storage block 146.

The user may access the media service platform 110 to transmit context information of the user. The context information storage block 146 may store the transmitted context information of the user.

The user may search the media service platform 110 for a service supported by a system. The service search block 140 may search for a service supported by the media service platform 110, and provide the user with a result of the service search.

When the service is found, the user may configure a desired service through the media service platform 110. The service configuration block 142 may configure the desired service according to a request of the user and provide the user with a service configuration result.

The user profile block 144 may provide a profile of the user to another block within the media service block 110 by storing the profile of the user.

The service manager 120 may manage a state of the service resource 130 corresponding to a service request of the user, and may provide the user with an optimal service resource selected based on a criterion, for example, a QoS included in the service request. The service manager 120 may establish an optimal service path by collecting and analyzing service resources satisfying the QoS in response to the service request of the user.

The service manager 120 may configure and manage the service profile based on the service request of the user and context information of the user.

In response to a service change request of the user, the service manager 120 may adapt to the service change request by collecting, analyzing, and determining a service resource used to provide a changed service.

The service manager 120 may include a service operation block 150, a service routing block 152, a service profile management block 154, a service resource management block 156, a service bridge block 158, and a QoS operation block 160.

The service operation block 150 may receive a service request from the media service platform 110, and may transfer the received service request to another block of the service manager 120. In response to the service request, the service operation block 150 may transmit a response to the media service platform 110.

The service operation block 150 may receive user context information from the media service platform 110, and may provide the context information to another block of the service manager 120. The service operation block 150 may transmit the context information to the media service platform 110.

The service routing block 152 may request the service resource management block 156 for an optimal service resource and may collect an available service resource with respect to the service request. The service routing block 152 may provide a result of the available service resource collection to another block of the service manager 120.

The service profile management block 154 may configure and manage the service profile based on the service request of the user and the context information. The service profile may include an access right of the user, a service right, apparatus information, service providing state information, and service information.

The service resource management block 156 may maintain latest state information associated with the service by periodically monitoring a service provided by the service manager 120. The service resource management block 156 may maintain and provide an environment for providing an optimal service resource corresponding to the service request of the user, using latest state information associated with the service. The service resource management block 156 may include state information of a service provided by a service provider.

Even though not illustrated in FIG. 1, the service bridge block 158 may communicate with a service manager of another service area, and may provide an access to a service resource of the other service area based on a QoS agreement with the service manager of the other service area. For example, the service manager 120 may provide, to the other service manager within the service delivery platform 100, an available service resource among the service resources 130 managed by the service manager 120 based on the QoS agreement.

The QoS operation block 160 may constrain a selection of a service resource for providing the service in order to provide the QoS requested by the user. The QoS operation block 160 may monitor and manage service resources, and may provide a response with respect to a request of the service resource management block 156.

A service profile and resource database 162 may receive, from another block within the service manager 120, a request for storing information associated with the service profile and the resource, and may store the requested information.

The other block of the service manager 120 may request the service profile and resource database 162 for the stored information associated with the service and the resource.

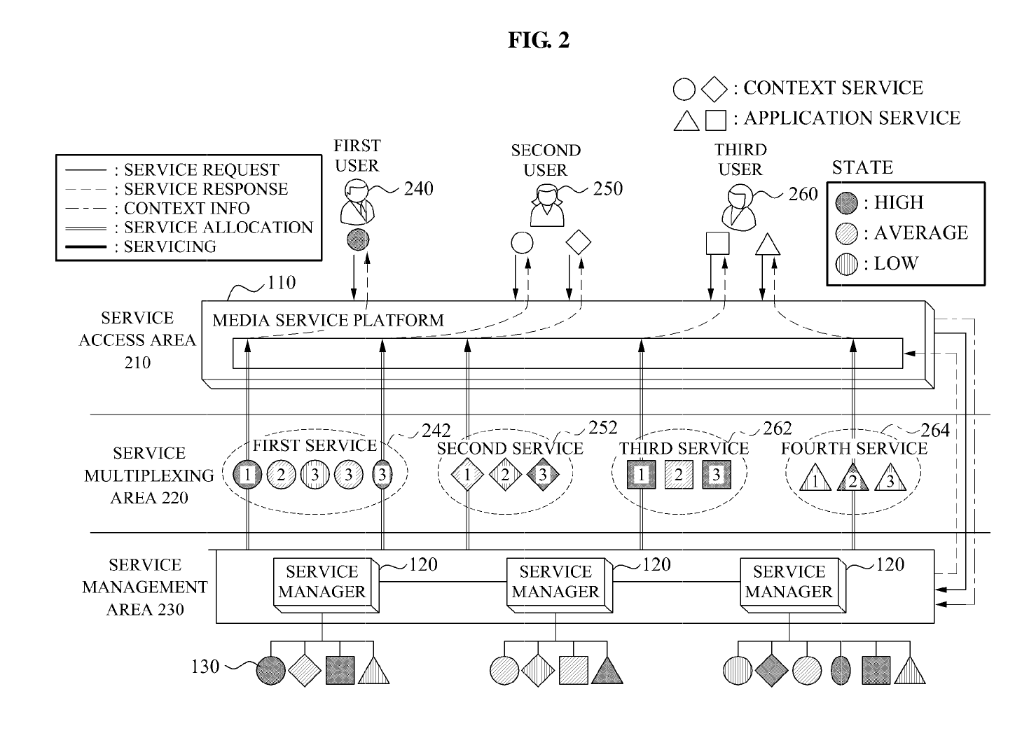

The service resource 130 may correspond to an abstracted physical resource. FIG. 2 is a diagram illustrating an example of a service based operation structure according to an embodiment of the present invention.

An operation structure of the present example corresponds to the service based operation structure in the entire structure including a media service platform 110 and a plurality of service providers 120.

The service based operational structure may be classified into a service access area 210, a service multiplexing area 220, and a service management area 230.

The service access area 210 may corresponds to an access where a user accesses a service.

As indicated by a solid line, the user may access the media service platform 110 to transmit context information and to search for and request a service. A type and a QoS of the service requested by the user are expressed using figures.

Each service may have a type. Services may be classified into a context service type, expressed using a circular shape and a rhombus shape, and an application service type, expressed using a triangular and a rectangular shape.

Each service may have a QoS. The QoS may be classified into “high” expressed as a completely filled figure, “average” expressed as a figure filled with diagonal lines, and “low” expressed as a figure filled with vertical lines.

A figure with an unfilled inside indicates that the service requested by the user does not impose constraints on QoS.

For example, referring to FIG. 2, a first user 240 may request a first context service having a high QoS. The first context service is indicated as a circular shape. A second user 250 may request the first context service and a second context service without constraining the QoS. A third user 260 may request a first application service and a second application service without constraining the QoS.

The media service platform 110 may transmit, to a corresponding service manager 120 of each user, context information indicated by a one-dot chain line and service request information indicated by a solid line that are received from each user.

The service management area 230 may correspond to an area where the service managers 120 manage service resources.

The service multiplexing area 220 may correspond to an area where the service bridge block 158 of the service manager 120 determines an optimal service resource suitable for a user request through exchange of information with other service managers 120 having different service resources. The QoS requested by the user may be a criterion for determining the optimal service resource.

For example, for the information exchange in the service multiplexing area 220, service resources that may satisfy the requested QoS may be collected and analyzed. Referring to FIG. 2, the first context service requested by the first user 240 may be provided by all the service managers 120. The first context services provided by the service managers 120 may be collected in the first multiplexing area 220. A QoS of each of the collected first context services may be analyzed

In addition, for decision in the service multiplexing area 210, an optimal service path may be established to satisfy the requested QoS. For example, it may be assumed that the first user 240 requests a first context service with a high QoS. Accordingly, only first context services having a high QoS among the analyzed first context services may be selected as a service to be provided. The service manager 120 may force a use of a particular service resource for providing the QoS requested by the user.

The service multiplexing area 220 may be considered as an area where services provided by the total service managers 120 constitute sets 242, 252, 262, and 264 based on types of the services. The service requested by the user may correspond to one of the sets 242, 252, 262, and 264. A service satisfying the user requested criterion, for example, the QoS may be selected from services included in the one set and be provided to the user.

A service resource determined by service multiplexing may be allocated to the user requesting the service, and an allocation result may be transferred to the user through the media service platform 110 as indicated by double lines.

The service resource transferred to the first user 240 corresponds to a context service having a high QoS, as requested by the first user 240.

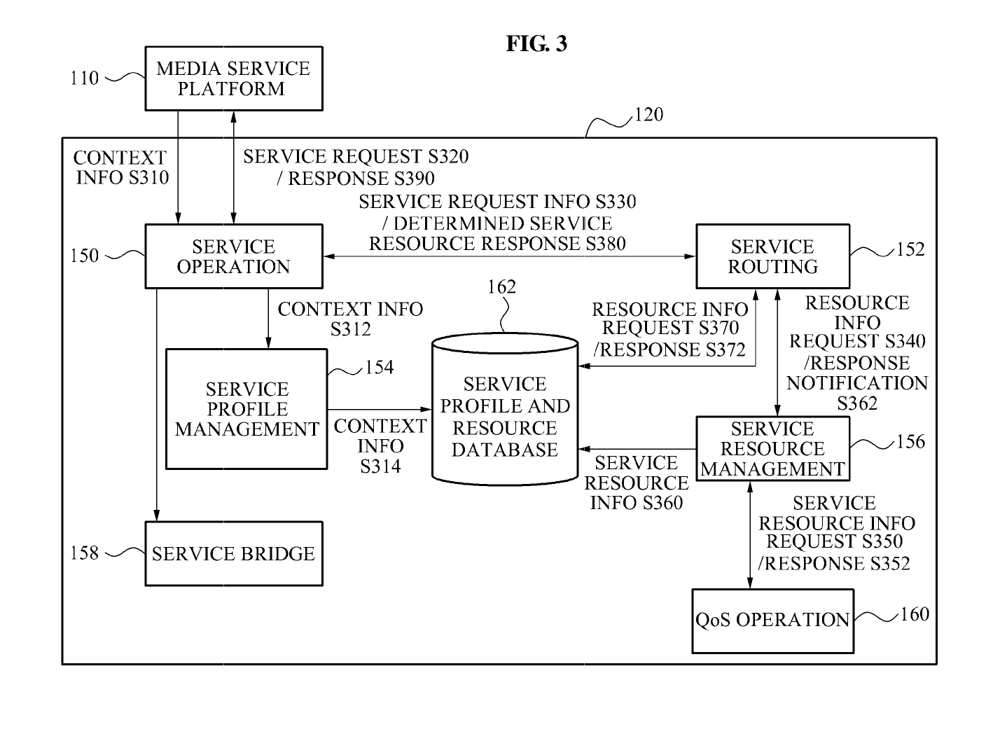

FIG. 3 is a diagram illustrating a message flow between constituent blocks of a service manager according to an embodiment of the present invention.

FIG. 3 shows a message flow within a service manager 120 for providing a service within a single service area.

In S310, a media service platform 110 may transmit context information of a user to a service operation block 150. In S312, the service operation block 150 may transmit the received context information to a service profile management block 154. In S314, the service profile management block 154 may transmit the received context information to a service profile and resource database 162.

In S320, the media service platform 110 may transmit a new service request or a service change request (hereinafter, a service request) to the service operation block 150.

In S330, the service operation block 150 may transmit information associated with the service request to a service routing block 152. In S340, the service routing block 152 may transmit details of the received service request to a service resource management block 156, and may request a resource required in response to the received service request.

In S350, the service resource management block 156 may transmit details of the service request to a QoS operation block 160, and request the QoS operation block 160 for service resource information. In S352, the QoS operation block 160 may transmit, as a response, the service resource information to the service resource management block 156.

In S360, the service resource management block 156 may receive the service resource information and store the service resource information in the service profile and resource database 162. In S362, the service resource management block 156 may inform the service routing block 152 about that the service resource information is received as the response.

In S370, the service routing block 152 having been informed may request the service profile and resource database 162 for user context information and resource state information. In S372, the service profile and resource database 162 may transmit, to the service routing block 152 as a response, the requested user context information and the resource state information.

The service routing block 152 may determine an optimal service resource based on the received user context information and the resource state information. In S380, the service routing block 152 may transmit, as a response, the determined optimal service resource to the service operation block 150.

In operation S390, the service operation block 150 receiving the response may transmit a final response to the media service platform 110 in response to the service request.

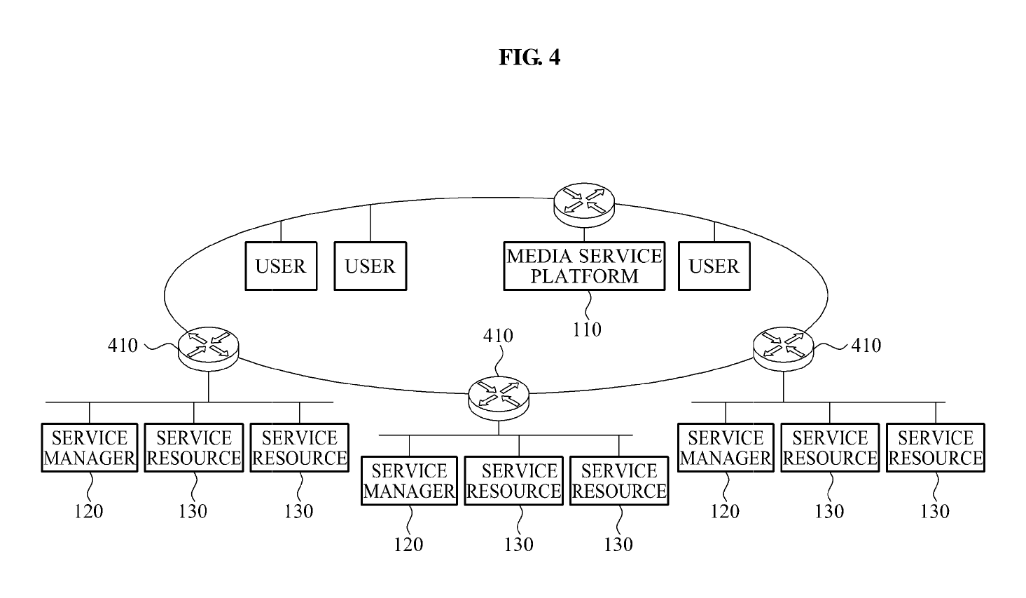

FIG. 4 is a diagram illustrating a connection between a plurality of service areas according to an embodiment of the present invention.

Referring to FIG. 4, a plurality of users, a media service platform 110, service managers 120, and service resources 130 within a service area are connected over a communication network.

In FIG. 4, at least one service manager 120 may be connected to the entire system over the communication network. Each service manager 120 may manage at least one service resource 130. Each service manager 120 and at least one service resource 130 may constitute a single service area 410.

The plurality of service managers 120 may interact with each other over the communication network.

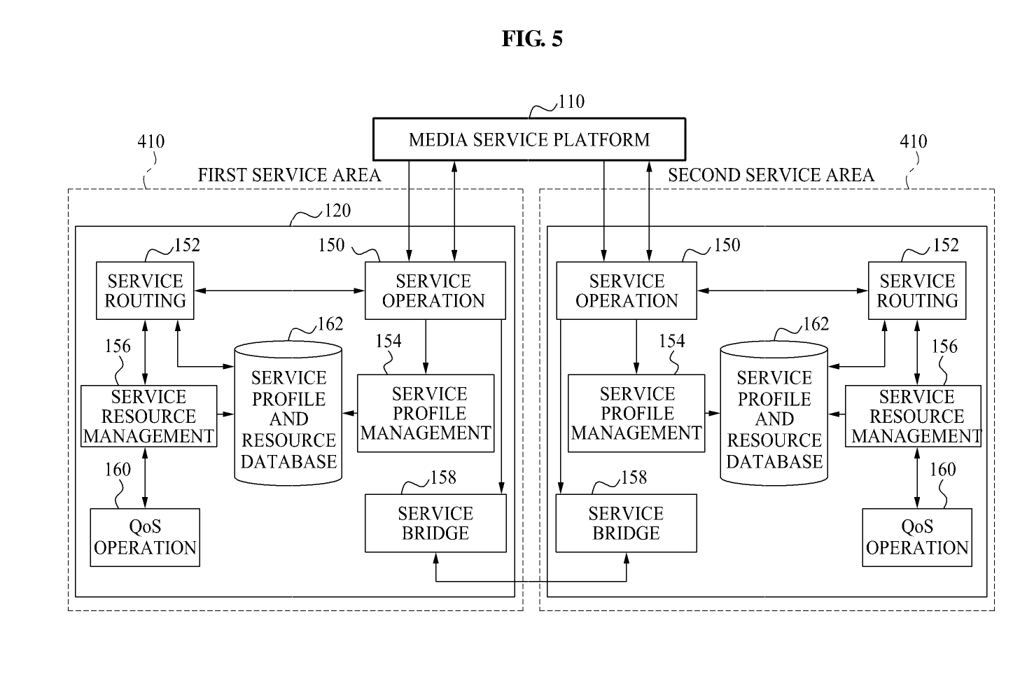

FIG. 5 is a diagram illustrating an interoperation between a plurality of service managers managing different service areas according to an embodiment of the present invention.

Referring to FIG. 5, a media service platform 110, and service managers 120 corresponding to a first service manager and a second service manager are connected to each other over a communication network.

The service manager 120 corresponding to the first service manager may belong to a service area 410 corresponding to a first service area. The service manager 120 corresponding to the second service manager may belong to a service area 410 corresponding to a second service area.

Descriptions related to the service managers 120 and constituent blocks thereof described above with reference to FIG. 1 through FIG. 4 may be applicable to the service manager 120 corresponding to the first service manager and the service manager 120 corresponding to the second service manager of FIG. 5.

The both service managers 120 may interact with each other. A service interaction between the both service managers 120 may be provided by a service bridge block 158.

The service bridge block 158 may determine whether to assign a right to search an available service resource managed by the corresponding service manager 120, and to access a service based on a QoS agreement between the first service area and the second service area.

The QoS operation block 160 may perform a functionality of a QoS enabler that operates a QoS of a service managed by the corresponding service manager 120.

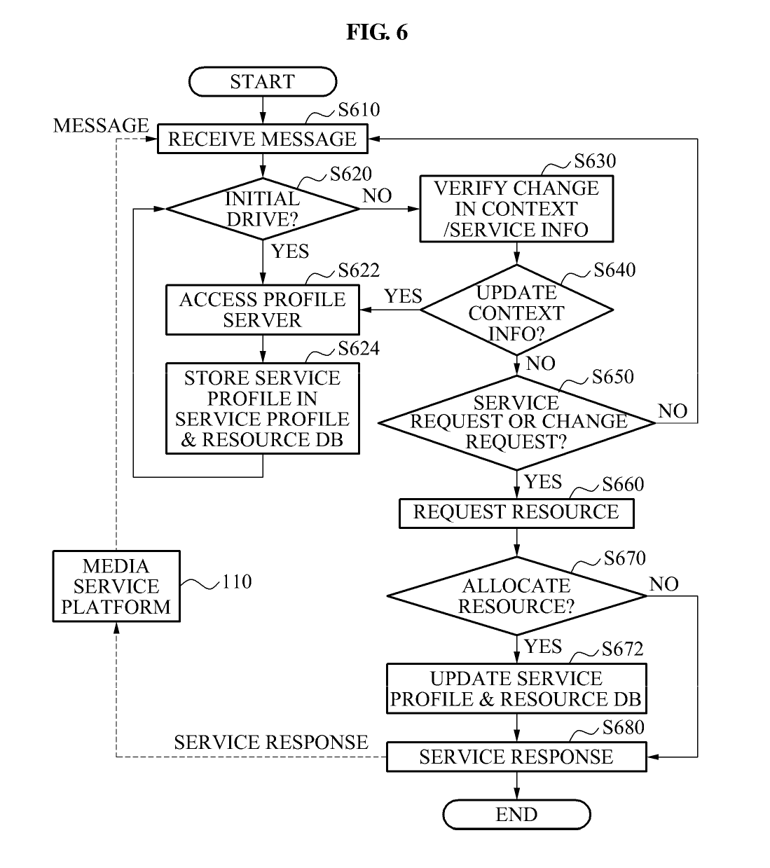

FIG. 6 is a flowchart illustrating an operation of a service manager according to an embodiment of the present invention.

In operation S610, a message may be received from a media service platform 110.

In operation S620, whether an operation of the received message corresponds to an initial drive may be determined. When the operation corresponds to the initial drive, there is a need to generate a service profile and thus, operations S622 and S624 may be performed. Conversely, when the operation does not correspond to the initial drive, operation S630 of verifying a change in context and service information may be performed.

In operation S622, a profile server may be accessed to collect user information, context information, and service request information.

In operation S624, the service profile may be generated based on the collected user information, context information, and service request information. The generated service profile may be stored in a service profile and resource database 162. When the service profile is generated in operation S624, operation S620 may be performed again.

In operation S630, a procedure for verifying whether the received message indicates a change in the context information and the service information may be performed.

In operation S640, whether the received message indicates updating of the context information may be determined. When the received message indicates updating of the context information, the profile server may need to be accessed for updating of the service profile. Accordingly, operation S622 may be performed.

When the received message does not indicate updating of the context information, whether the received message indicates a new service request or a service change request may be determined in operation S650.

When the received message does not indicate the new service request or the service change request, the service manager 120 may wait for a subsequent message to be received. When the subsequent message is received, operation S610 may be repeated.

Conversely, when the received message indicates the new service request or the service change request, a resource request may be transmitted to the QoS operation block 160 in operation S660.

When the source is requested, whether the requested resource is allocated may be determined in operation S670.

When the requested resource is allocated, the service profile and resource database 162 may be updated in operation S672, and a service response may be transmitted to the media service platform 110 in operation S680.

Conversely, when the requested resource is not allocated, the service response may be transmitted to the media service platform 110 in operation S680.

Descriptions made above with reference to FIG. 1 through FIG. 5 may be applicable to the present embodiment. Accordingly, further detailed description related thereto will be omitted here.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A service delivery platform, comprising:
a media service platform to provide a service to a user; and
a plurality of service managers to manage at least one service resource,
wherein the media service platform transmits a service request of the user to a predetermined service manager and the predetermined service manager selects a service resource for providing a service from the at least one service resource managed by each of the plurality of service managers in interoperation with other service managers.

2. The service delivery platform of claim 1, wherein the media service platform comprises:
a context information storage block to store context information of the user;
a service search block to search for a service supported by the media service platform, and to provide the user with a result of the service search;
a service configuration block to configure and manage a service profile based on the service request of the user and the context information of the user; and
a user profile block to store a profile of the user.

3. The service delivery platform of claim 1, wherein the predetermined service manager provides, to another service manager, an available service resource among at least one service resource managed by the predetermined service based on a quality of service (QoS) agreement between the plurality of service managers.

4. The service delivery platform of claim 1, wherein the predetermined service manager selects a service resource for providing a service from the at least one service resource based on a criterion included in the service request.

5. The service delivery platform of claim 4, wherein the predetermined service manager selects, from the at least one service resource, a service resource satisfying a requested QoS included in the service request.

6. The service delivery platform of claim 1, wherein:
the service resource has a service resource type, and
the at least one service resource managed by each of the plurality of service managers has the same type as a service type requested by the service request.

7. The service delivery platform of claim 1, wherein when the service request corresponds to a service change request, the predetermined service manager adapts to the service change request by collecting, analyzing, and determining a service resource used to provide a changed service.

8. A service manager managing a plurality of service resources, comprising:
a service operation block to receive a service request from a media service platform, and to transmit a response to the media service platform in response to the service request; and
a service bridge block to provide an access to a service resource managed by another service manager within a network,
wherein the service manager selects a service resource for providing a service according to the service request in interoperation with the other service manager.

9. The service manager of claim 8, further comprising:
a service resource management block to maintain latest state information associated with a service provided by the service manager; and
a service routing block to request the service resource management block for an optimal service resource according to the service request.

10. The service manager of claim 8, further comprising:
a service profile management block to configure and manage a service profile based on context information of a user and the service request,
wherein the service profile comprises at least one of an access right of the user, a service right, apparatus information, and service providing state information.

11. The service manager of claim 8, further comprising:
a quality of service (QoS) operation block to constrain a selection of the service resource for providing the service in order to provide a QoS requested by the service request.

12. A service providing method, comprising:
receiving a service request from a user;
collecting a service resource associated with the service request from service resources managed by a plurality of service managers;
determining a service resource for providing a service by analyzing the collected service resources;
allocating the determined service resource to the user; and
providing the allocated service resource to the user.

13. The method of claim 12, wherein:
the service request comprises a QoS, and
the determining comprises:
analyzing a QoS of each of the collected service resources; and
selecting, from service resources satisfying the QoS, the service resource for providing the service.

14. The method of claim 12, wherein:
the service request has a service type, and
the service resource associated with the service request has the same service type as a service type of the service request.
